(19) United States
(12) Patent Application Publication
(10) Pub. No.: US 2002/0142649 A1
(43) Pub. Date: Oct. 3, 2002

(54) Pluggable transceiver delatch

(76) Inventors: Brent Baugh, Palo Alto, CA (US); Wayne Hon Fu, Menlo Park, CA (US); Stephen P. Merrick, San Jose, CA (US); Robert Sean Murphy, Sunnyvale, CA (US); Richard A. Ruh, Monte Sereno, CA (US); Matthew K. Schwiebert, Cupertino, CA (US)

Correspondence Address: AGILENT TECHNOLOGIES, INC., Legal Department, 51U-PD, Intellectual Property Administration, P. O. Box 58043, Santa Clara, CA, 95052-8043, US

(21) Appl. No.: 09/822,910

(22) Filed: Mar. 29, 2001

(51) Int. Cl. H01R 13/60

(52) U.S. Cl. 439/532

(57) ABSTRACT

A mechanical device is used for releasing and extracting a fiber optic module from a cage.

### FIELD OF THE INVENTION

The present invention relates to a user-friendly device used to release and extract a pluggable transceiver. More particularly, the present invention relates to a device used to release and extract a pluggable fiber optic transceiver outlined by the Small Form-factor Pluggable (SFP) MultiSource Agreement (MSA).

### BACKGROUND

The internet and networking is a well known vehicle for information and data exchange in the last half twentieth century. In the late twentieth century and early twenty-first century, the high demand of transferring a larger volume of data and at faster rates has spurred the networking industry to design and manufacture faster and more compact modular data transfer devices. This led to the development of the Small Form-factor (SFF) MSA.

The demand for flexibility for upgrades and ease of repairs now drives data transfer devices to be interchangeable in routers and storage devices. The Gigabit Interface Converter (GBIC) standard was developed to meet the need of a pluggable transceiver, though the specified size was quite large. In the early twenty-first century, the need for a pluggable and a more compact transceiver drove the development of the SFP MSA. The SFP MSA outlines the standards for a pluggable fiber optic transceiver as well as the various mounting configurations.

With the advent of the SFP MSA, methods and devices had to be developed to release and extract the fiber optic transceiver from a cage, which holds the transceiver during operation, located inside the user's box. These user-friendly devices have to functional and be easy to use while the transceiver is used in both a single sided array configuration and belly to belly array configuration.

### SUMMARY

The system comprises of a piece part that interfaces with the transceiver housing. The body of the delatch is used as a slide and interface with the housing. The front fingers of the delatch serve two purposes.

The first purpose is to act as a device to hold the delatch in the housing and prevents the user from pulling the delatch out of the housing during module extraction. This feature is similar to the plastic buckles found on backpacks, bags, and suitcases. The spring fingers deflect inward to allow the delatch to slide into the housing slot and then spring back to their original position. The catch surface overlaps with the end of the housing slot and prevents the delatch from being inadvertently removed from the housing.

The second purpose of the front fingers is to act as the working delatch mechanism to lift the tab on the SFP cage which holds the transceiver in place. The sloped surfaces of the delatch act as ramps to push the SFP cage tab over the shear pin on the housing. This will then release the transceiver from the SFP cage and allow the transceiver to be extracted.

The delatch is used by a sequence of two steps. The delatch is first pushed inward towards the cage to delatch the transceiver. This forward motion allows the delatch to lift the SFP cage off the shear pin. The user then pulls outward on the transceiver or delatch to extract the device.

The addition of a plastic “tongue” or a knob can be added to the delatch to allow for a more convenient feature to grasp for module extraction. The knob can also be offset to one side to provide an asymmetric feature on the piece part. This can then be used in a belly to belly configuration as outlined in the SFP MSA.

Texturing can be added to various surfaces of the delatch to make the device more user friendly by providing more friction for grasping and actuating.

### BRIEF DESCRIPTION OF THE DRAWINGS

FIG. 1 is an illustration of the preferred embodiment of the invention;

FIG. 2 is a schematic of the key features of the present invention;

FIG. 3 is a schematic showing the invention in the normal resting configuration with the housing;

FIG. 4 is a schematic showing the invention with a modified catch in the normal resting configuration with the housing;

FIG. 5 is a detail of the modified catch feature on the delatch and housing;

FIG. 7 is an illustration of a possible variation of the invention.; and

FIG. 6 is a cross section showing the delatch in the normal resting configuration with the housing and tab.

### DETAILED DESCRIPTION

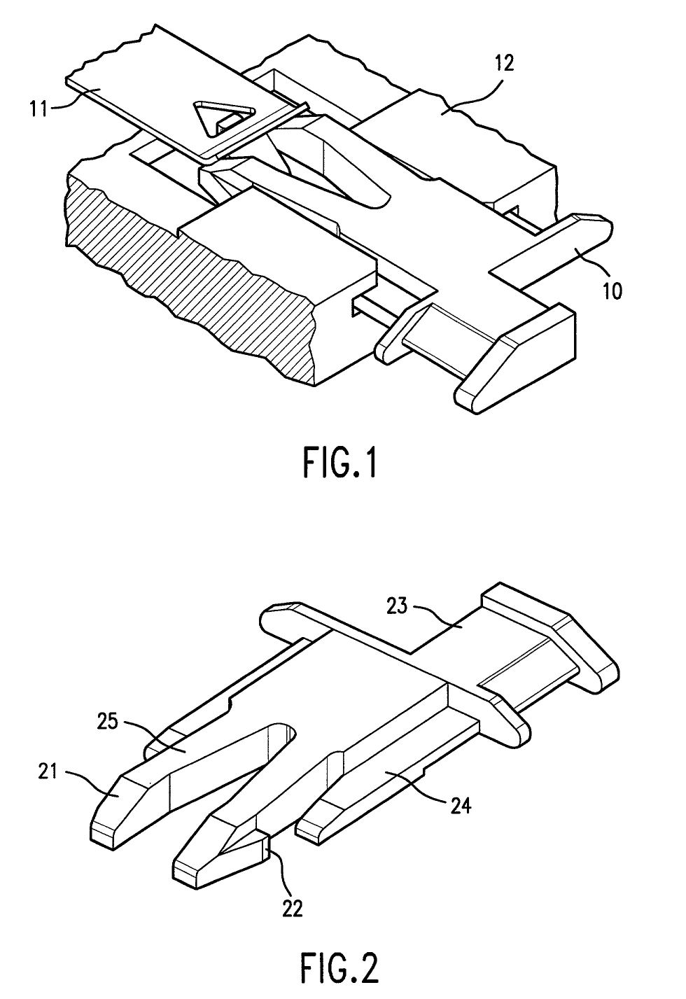

As shown in the drawings, the present invention is embodied in the delatch, generally referred to by the reference numeral 10, of the type that may be used in a SFP MSA fiber optic transceiver or any other type of pluggable transceiver. Referring the FIG. 1 of the drawings, the delatch is comprised of a plastic piece part. The delatch sits in a slot feature located on the housing 12 which is held in the cage by a tab 11 from the cage.

Although the delatch 10 is manufactured out of plastic, it is understood that the material selection of the present invention are applicable to different types of materials as well. For example, the delatch 10 can be machined or casted out of metal or made of other materials other than plastic to make it more suitable to be used in different applications or environments. By way of example, the delatch 10 could be machined of metal to meet electrical or EMI requirements. Other endless variations are possible. The elastic modulus of the delatch is preferably between 150 MPa and 15000 MPa.

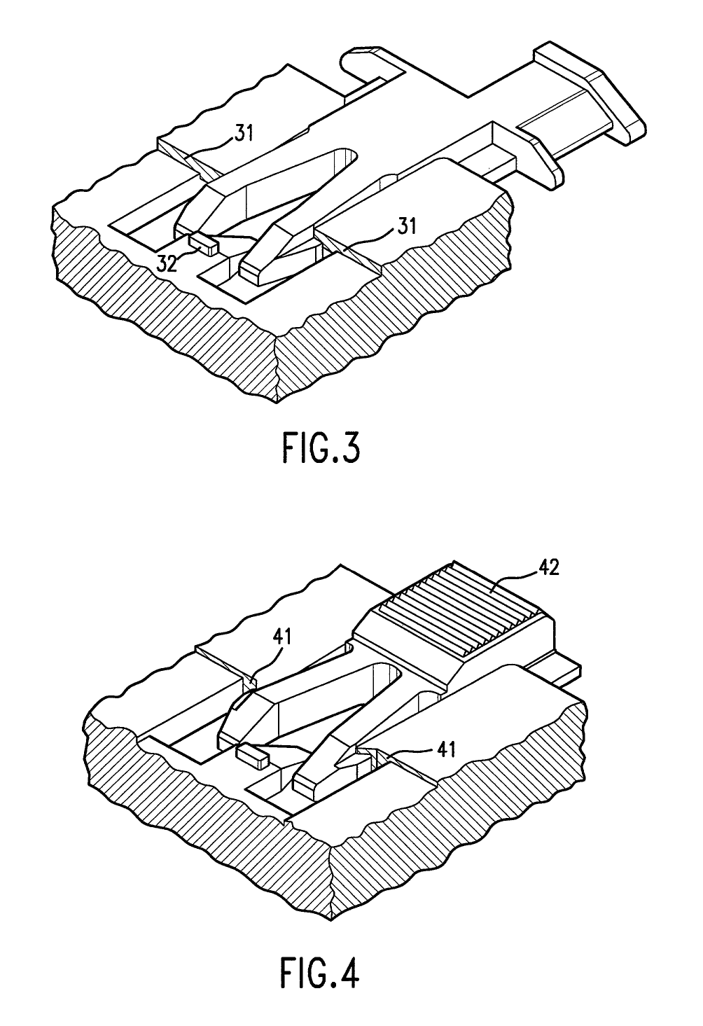

In FIG. 2, the various features of the delatch 10 are illustrated in greater detail. The spring arms 25 are designed so they will deflect without yielding or failing the material. It is also designed to have enough spring force to help the catch feature 22 hold the delatch 10 in the housing 12 securely. The corresponding catch feature 31 on the housing 12 is shown in FIG. 3. The catch feature 22 can be modified to increase or decrease the interference with the corresponding catch feature 31 to make is harder or easier to remove the delatch 10 from the housing 12.

A variation of the catch feature 31 is illustrated in FIG. 4. As shown in detail on FIG. 5, a catch barb 51 is added to the catch feature 22 on the delatch 10. A corresponding barbed catch feature 41 is added to the housing 12. If attempts are made to remove the delatch 10 from the housing 12, the catch barb 51 on the delatch 10 and the corresponding catch feature 41 on the housing 12 will force the spring arms 22 to spread outward and grab the housing 10. This prevents the delatch 10 from being removed.

The slide guide 24 helps to guide the delatch 10 into the slot feature in the housing and helps the delatch 10 operate. The slide guide 24 also prevents the delatch 10 from being lifted out of the housing 12. The ramps 21 at the end of the spring arms 25 provides the working surface to lift the tab 11 from the cage over the shear pin 32 to release the module.

The extended knob 23 is placed asymmetrically on the delatch 10 to allow for easier access when the transceiver is used in a belly to belly configuration. Texturing 42 and other features can be added to the extended knob 23 or surrounding features to make it easier for the user to grasp the delatch 10 for extraction.

The delatch 10 in FIG. 6 shows the configuration of the delatch 10 modified so the extended knob 23 is removed and a plastic tab 61 is put in its place.

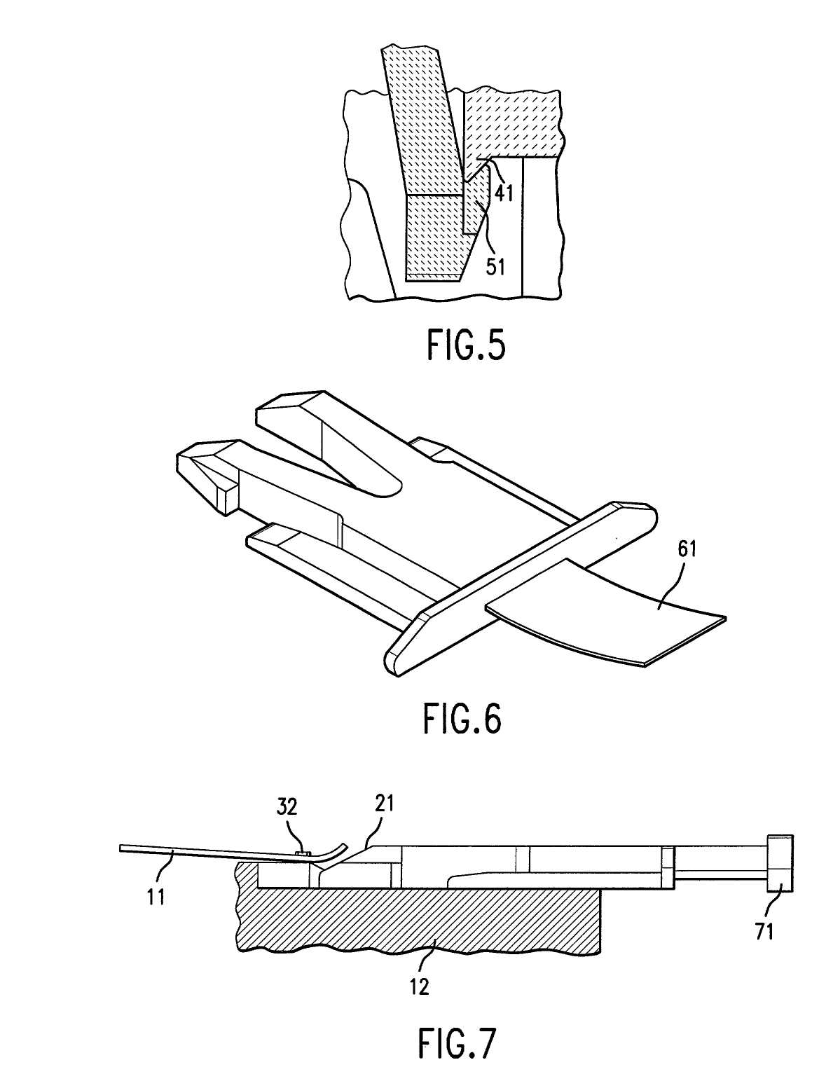

FIG. 7 shows the helps to illustrate the operation of the delatch 10. The delatch 10 is initially pushed from the back of the extended knob 71 towards the tab 11 and shear pin 32. The ramp 21 at the end of the spring fingers 25 lift the tab 11 over the shear pin 32, which is a feature on the housing 12. This in turn releases the housing 12 from the cage and the transceiver is free to be extracted. The delatch 10 is then grasped by the extended knob 23 and pulled away from the tab 11. This extracts the transceiver free from the cage. A variation of this step is to release the module as described above but the housing 12 is grasped to extract the module.

While a particular form of the invention has been illustrated and described, it will be apparent that various modifications can be made without departing from the spirit and scope of the invention. Accordingly, it is not intended that the invention be limited, except as by the appended claims.

We claim:

1. An optical module assembly comprising:
a housing having a recess;
a pluggable transceiver seated in the recess;
a tab, having a hole, integrated into the housing, operative to partially cover the pluggable transceiver; and
a delatch having a catch, positioned over the pluggable transceiver, when the pluggable transceiver shear pin engages the hole, the pluggable transceiver is secured;
wherein the pluggable transceiver may be released when the delatch is pushed then pulled.

2. An optical module assembly, as defined in claim 1, the catch is barb.

3. An optical module assembly, as defined in claim 1, the delatch further including a handle.

4. An optical module assembly, as defined in claim 3, wherein the handle is placed in an offset position.

5. An optical module assembly, as defined in claim 3, wherein the handle is a plastic tongue.

6. An optical module assembly, as defined in claim 3, wherein the handle is an extended knob.

7. An optical module assembly, as defined in claim 6, the handle further including a pad to be used when the delatch is pushed in.

8. An optical module assembly, as defined in claim 7, wherein the pad is textured to allow gripping of the delatch.

9. An optical module assembly as defined in claim 3, wherein the handle is textured to allow gripping of the delatch.
